(19) United States
(12) Patent Application Publication
(10) Pub. No.: US 2022/0011556 A1
(43) Pub. Date: Jan. 13, 2022

(54) ZOOM LENS

(71) Applicant: AAC Optics Solutions Pte. Ltd., Singapore city (SG)

(72) Inventors: Jarno Matikainen, Tampere (FI); Tomi Lintulahti, Tampere (FI)

(21) Appl. No.: 17/005,353

(22) Filed: Aug. 28, 2020

(30) Foreign Application Priority Data
Jul. 9, 2020 (CN) 202010659876.2

(51) Int. Cl. G02B 15/14

(52) U.S. Cl. CPC G02B 15/142

(57) ABSTRACT

The present invention provides a zoom lens, at least including a first camera lens, a second camera lens, a first motor assembly, and a housing. The first camera lens and the second camera lens are installed in the housing. The first motor assembly is installed to the housing and connected to the first camera lens, so as to drive the first camera lens to move relative to the second camera lens to change a focal length. For the zoom lens provided by the present invention, the first camera lens is driven by the first motor assembly, which requires a lower cost, a simpler structure, and is easier to process, thereby better meeting the actual use requirements.

### TECHNICAL FIELD

The present invention relates to the field of video technologies, and particularly, to a zoom lens.

### BACKGROUND

With the advance of modern video technologies, requirements on the resolution and quality of the camera have been increasing in recent years. Zoom lens is one of pivotal components of the camera. Through optical zooming of the zoom lens, both far and close images can be clearly imaged. Generally, the zoom lens drives each camera lens to move relative to each other by means of an interaction between a coil and a magnetic steel, in order to change a focal length. However, such a method requires a high cost and a complicated structure.

### SUMMARY

The present invention provides a zoom lens, which provides a new solution of driving the movement of the camera lens.

An embodiment of the present invention provides a zoom lens, including at least a first camera lens, a second camera lens, a first motor assembly, and a housing. The first camera lens and the second camera lens are installed in the housing. The first motor assembly is installed to the housing and connected to the first camera lens and is configured to drive the first camera lens to move relative to the second camera lens.

As an improvement, the zoom lens further includes a first connector; the first camera lens includes a first connection hole, the first connector has one end connected to an output shaft of the first motor assembly and the other end connected to the first camera lens through the first connection hole.

As an improvement, the first connector is arranged along a length direction of the zoom lens and is engaged with the first connection hole through screw threads; the first motor assembly is configured to drive the first connector to rotate relative to the first connection hole in such a manner that the first camera lens moves along the first connector, so as to change a distance between the first camera lens and the second camera lens.

As an improvement, the second camera lens is movable relative to the housing to change a distance between the first camera lens and the second camera lens.

As an improvement, the zoom lens further includes a second motor assembly; the second motor assembly is installed to the housing and connected to the second camera lens and is configured to drive the second camera lens to move relative to the first camera lens.

As an improvement, the zoom lens further includes a second connector; the second camera lens includes a second connection hole, the second connector has one end connected to an output shaft of the second motor assembly and the other end connected to the second camera lens through the second connection hole.

As an improvement, the second connector is arranged along a length direction of the zoom lens and is engaged with the second connection hole through screw threads; and the second motor assembly is configured to drive the second connector to rotate relative to the second connection hole in such a manner that the second camera lens moves along the second connector to change a distance between the first camera lens and the second camera lens.

As an improvement, the housing is provided with a guide channel, and the guide channel is arranged along a length direction of the zoom lens; and the first camera lens and the second camera lens are installed to the guide channel and are movable relative to the guide channel.

As an improvement, a first groove is provided at a side of the first camera lens facing towards the housing, a first ball is provided in the first groove, and the first camera lens is in contact with an inner wall of the guide channel through the first ball.

As an improvement, a second groove is provided at a side of the second camera lens facing towards the housing, a second ball is provided in the second groove, and the second camera lens is in contact with an inner wall of the guide channel through the second ball.

The zoom lens provided by the present invention at least includes the first camera lens, the second camera lens, the first motor assembly and the housing, the first camera lens and the second camera lens are installed in the housing, and the first motor assembly is installed to the housing and connected to the first camera lens, so as to drive the first camera lens to move relative to the second camera lens to change a focal length. For the zoom lens provided by the present invention, the first camera lens is driven by the first motor assembly, which requires a lower cost and a simpler structure, and is easier to process, thereby better meeting the actual use requirements.

It should be understood that the above general description and the following detailed description are merely illustrative and are not intended to limit the present invention.

### BRIEF DESCRIPTION OF DRAWINGS

FIG. 1 is a structural schematic diagram of a zoom lens according to an embodiment of the present invention;

FIG. 2 is a front view of FIG. 1;

FIG. 3 is a side view of FIG. 1;

FIG. 4 is a cross-sectional view along A-A of FIG. 3;

FIG. 5 is a cross-sectional view along B-B of FIG. 3;

FIG. 6 is a schematic structural diagram of a first camera lens of a zoom lens according to an embodiment of the present invention; and

FIG. 7 is a schematic structural diagram of a second camera lens of a zoom lens according to an embodiment of the present invention.

### REFERENCE SIGNS

1—first camera lens;
11—first groove;
12—first lens group;
13—first connection hole;
14—first ball;
15—first shell
2—second camera lens;
21—second groove;
22—second lens group;
23—second connection hole;
24—second ball;
25—second shell;
3—housing;
31—guide channel;
4—first motor;
5—second motor assembly;
6—first connector assembly;
7—second connector.

The drawings herein are incorporated into and constitute a part of the present specification, for illustrating embodiments of the present invention and explaining principles of the present invention together with the specification.

### DESCRIPTION OF EMBODIMENTS

For clearly understanding technical solutions of the present invention, embodiments of the present invention will be described in detail with reference to the accompanying drawings.

It should be noted that the described embodiments are merely parts of, rather than all of the embodiments of the present invention. Based on the embodiments described in the present invention, any other embodiments obtained by those skilled in the art without paying creative efforts shall fall within the protection scope of the present invention.

The terms used in the embodiments of the present invention are merely for the purpose of describing particular embodiments, but not intended to limit the present invention. Unless otherwise noted in the context, the expressions in singular form such as “a”, “an”, “the” and “said” used in the embodiments and appended claims of the present invention are also intended to include plural form.

It should be understood that the term “and/or” used herein is merely a term describing relations of the associated objects, indicating three possible relationships. For example, “A and/or B” indicates three cases, i.e., only A existing, both A and B existing, and only B existing. In addition, the character “/” used herein generally indicates that the associated objects have an “or” relationship therebetween.

It should be noted that, the expressions such as “upper”, “lower”, “left”, “right” and the like mentioned in embodiments of the present invention are described with reference to the placement status in the accompanying drawings, and should not be construed as limitations to the embodiments of the present invention. In addition, it should also be understood that, in the context, when an element is described as being formed “above” or “below” another element, the element may be directly formed “above” or “below” the other element, or the element may be formed “above” or “below” the other element via an intermediate element.

With the advance of the modern video technologies, the requirements on resolution and quality of the camera have been increasing in recent years. Zoom lens is one of pivotal components of the camera. The zoom lens can change a position of a focal point of the camera by means of optical zooming, so as to locate a focal point of the camera at a position of the scene to be imaged, thereby improving the resolution and quality of the captured image. The zoom lens includes at least two camera lenses. The two camera lenses can move relative to each other to change a distance therebetween, thereby achieving zooming. Generally, the zoom lens drives each camera lens to move relative to each other by means of an interaction between a coil and a magnetic steel. However, such a method requires a high cost and a complicated structure, which are not conducive to actual production.

In view of the above, an embodiment of the present invention provides a zoom lens, which provides a new solution to drive the camera lens to move.

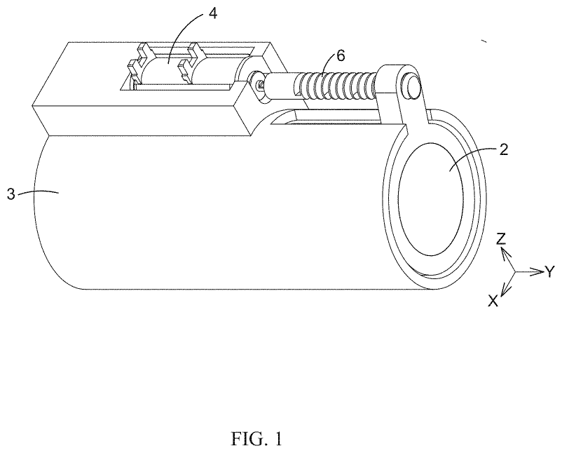

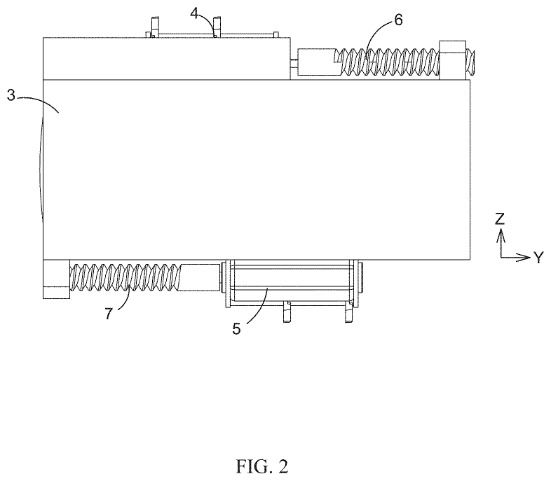

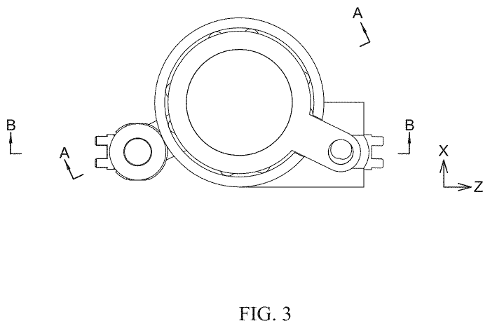

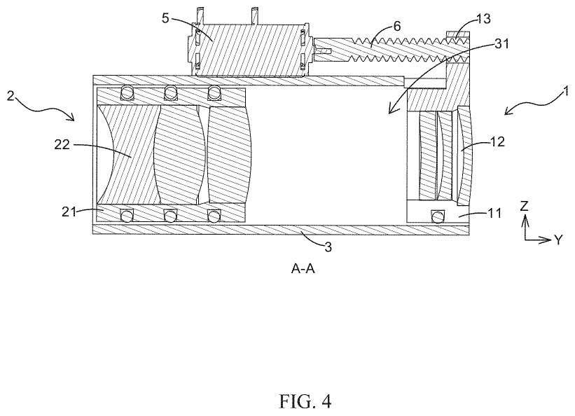

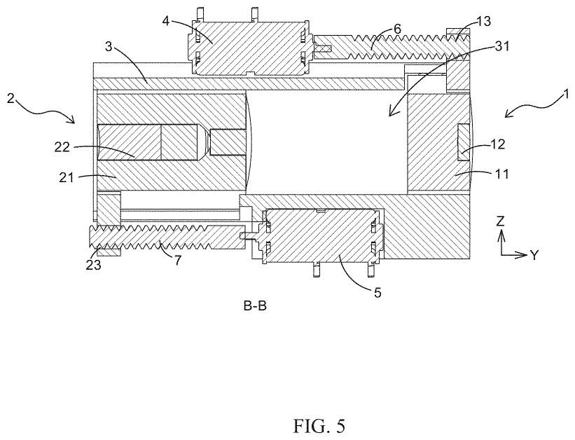

As shown in FIG. 1 to FIG. 3, an embodiment of the present invention provides a zoom lens. As shown in FIG. 4 and FIG. 5, the zoom lens includes at least a first camera lens 1, a second camera lens 2, and a housing 3. The first camera lens 1 and the second camera lens 2 are installed to the housing 3. The zoom lens further includes a first motor assembly 4 installed to the housing 3 and connected to the first camera lens 1, so as to drive the first camera lens 1 to move relative to the housing 3, so as to change a distance between the first camera lens 1 and the second camera lens 2, thereby changing a focal length of the zoom lens.

Compared with the method in which a coil and a magnet steel are used for driving, the first camera lens 1 driven by the first motor assembly 4 can move in a more stable manner. Meanwhile, it requires lower cost and a relatively simple structure, and the processing is less difficult. In this way, it is more convenient in actual production and use, and satisfies actual use requirements.

As shown in FIG. 4, in an embodiment, the housing 3 of the zoom lens includes a guide channel 31, and the first camera lens 1 is located in the guide channel 31 and can move along the guide channel 31.

The guide channel 31 is configured to guide the movement of the first camera lens 1, so as to increase an accuracy of relative positioning between the first camera lens 1 and the second camera lens 2, thereby improving the imaging quality.

As shown in FIG. 5, in an embodiment, the zoom lens may further include a first connector 6, and the first camera lens 1 includes a first connection hole 13. An end of the first connector 6 is connected to an output shaft of the first motor assembly 4, and another end of the first connector 6 is connected to the first camera lens 1 through the first connection hole 13. In this way, the first motor assembly 4 is connected to the first camera lens 1.

For example, the first motor assembly 4 drives the first camera lens 1 to move through the first connector 6, which allows the first motor assembly 4 to be positioned more flexibly, i.e., it is unnecessarily to be arranged close to the first camera lens 1. In this case, it is conducive to optimizing the overall structure of the zoom lens, and the overall structure of the zoom lens is more rational.

For example, as shown in FIG. 5, in an embodiment, the first connector 6 is arranged to be parallel with the guide channel 31. That is, the first connector 6 is arranged along a length direction Y of the zoom lens, and can be engaged with the first connection hole 13 through screw threads. The first motor assembly 4 is configured to drive the first connector 6 to rotate relative to the first connection hole 13, so as to move the first camera lens 1 along the first connector 6, thereby changing the distance between the first camera lens 1 and the second camera lens 2.

Since the first connector 6 can be engaged with the first camera lens 1 through screw threads, when the first motor assembly 4 drives the first connector 6 to rotate relative to the first connection hole 13, the first camera lens 1 will move along the first connector 6 to change the distance between the first camera lens 1 and the second camera lens 2.

With such a design, the first connector 6 can be formed to have a structure similar to a lead screw, which has advantages of less friction loss, higher transmission efficiency, and higher transmission accuracy. At the same time, it allows the reversible movement of the first camera lens 1, i.e., the first camera lens 1 can move towards or away from the second camera lens 2 by changing a rotation direction of the first motor assembly 4.

In an embodiment, the second camera lens 2 is located in the guide channel 31 of the housing 3 and can move along the guide channel 31, so as to change the distance between the first camera lens 1 and the second camera lens 2.

Such a design allows the zoom lens to be more flexible in terms of focusing, and both the first camera lens 1 and the second camera lens 2 can move to quickly change the distance between the first camera lens 1 and the second camera lens 2 when adjusting the focal distance, thereby achieving a fast adjustment of the focal distance, which better meets the actual use requirements.

As shown in FIG. 5, the zoom lens may further include a second motor assembly 5. The second motor assembly 5 is connected to the second camera lens 2 and configured to drive the second camera lens 2 to move along the guide channel 31.

Compared with the method in which a coil and a magnet steel are used for driving, the second camera lens 2 driven by the second motor assembly 5 can move in a more stable manner. Meanwhile, a method in which the motor assembly is used for driving requires lower cost, a relatively simple structure and lower processing difficulty, which is more convenient in actual production and use, and can better meet the actual use requirements.

The zoom lens may further include a second connector 7, and the second camera lens 2 includes a second connection hole 23. An end of the second connector 7 is connected to an output shaft of the second motor assembly 5, and the other end of the second connector 7 is connected to the first camera lens 1 through the first connection hole 13. In this way, the second motor assembly 5 is connected to the second camera lens 2.

For example, the second motor assembly 5 can drive the second connector 7 to drive the movement of the second camera lens 2, which allows the second motor assembly 5 to be positioned more flexibly, i.e., it is unnecessarily to be arranged close to the second camera lens 2. In this case, it is conducive to optimizing an overall structure of the zoom lens, and the overall structure of the zoom lens is more rational.

As shown in FIG. 5, in an embodiment, the second connector 7 is arranged to be parallel with the guide channel 31. That is, the second connector 7 can be arranged along the length direction Y of the zoom lens, and can be engaged with the second connection hole 23 through screw threads. The second motor assembly 5 is configured to drive the second connector 7 to rotate relative to the second connection hole 23, so as to move the second camera lens 2 along the second connector 7, thereby changing the distance between the first camera lens 1 and the second camera lens 2.

With such a design, the second connector 7 can be formed to have a structure similar to a lead screw, which has advantages of less friction loss, higher transmission efficiency, and higher transmission accuracy. At the same time, it allows the reversible movement of the second camera lens 2, i.e., the second camera lens 2 can move towards or away from the first camera lens 1 by changing a rotation direction of the second motor assembly 5.

The first camera lens 1 may include a first shell 15 and a first lens group 12, and the second camera lens 2 may include a second shell 25 and a second lens group 22. The first shell 15 is sleeved on the first lens group 12, and the second shell is sleeved on the second lens group 22. In an example, the first connection hole 13 may be provided in the first shell 15 and the second connector 23 may be provided in the second shell 25.

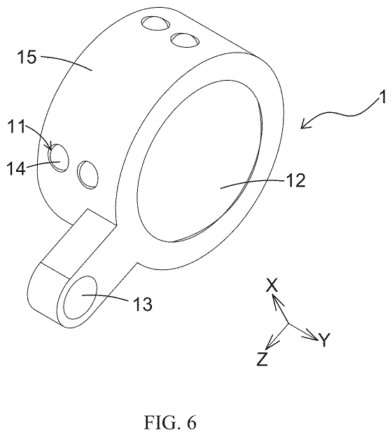

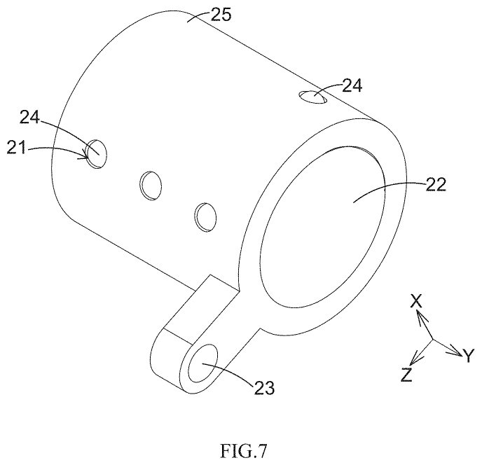

In order to facilitate the movement of the first camera lens 1 and the second camera lens 2 in the guide channel 31, as shown in FIG. 6, the first shell 15 is provided with a first groove 11, and a first ball 14 is arranged in the first groove 11, so that the first camera lens 1 is in contact with an inner wall of the guide channel 31 through the first ball 14; as shown in FIG. 7, the second shell 25 is provided with a second groove 21, and a second ball 24 is arranged in the second groove 21, so that the second camera lens 2 is in contact with the inner wall of the guide channel 31 through the second ball 24.

When each camera lens moves relative to the guide channel 31, such a design can convert sliding friction generated between the camera lens and the guide channel 31 into rolling friction, which is more conducive to the movement of the camera lens relative to the guide channel 31, and can also reduce wearing of the camera lens during the movement, thereby prolonging a service life of the first camera lens and the second camera lens.

It should be noted herein that the zoom lens provided in the embodiments of the present invention can be applied not only to a solution with two camera lenses, but to the zoom lens further including a third camera lens, a fourth camera lens, or even more camera lenses. Regardless the number of camera lenses in the zoom lens, the technical effects described above can be achieved by adopting the solution provided by the present invention, which will not be repeated herein.

An embodiment of the present invention provides a zoom lens. The zoom lens at least includes a first camera lens 1, a second camera lens 2, and a housing 3. The first camera lens 1 and the second camera lens 2 are installed in the housing 3. The first motor assembly 4 is installed to the housing 3 and connected to the first camera lens 1 for driving the first camera lens 1 to move relative to the second camera lens 2, so as to change a focal length. For the zoom lens provided by the present invention, the first camera lens 1 is driven by the first motor assembly 4, which not only requires a lower cost, but also has a simpler structure and is easier to process, thereby better meeting actual use requirements.

The above-described embodiments are merely preferred embodiments of the present invention, but not intended to limit the present invention. Various changes and modifications can be made to the present invention by those skilled in the art. Any modifications, equivalent substitutions and improvements within the principle of the present invention shall fall into the protection scope of the present invention.

What is claimed is:

1. A zoom lens, comprising at least a first camera lens, a second camera lens, a first motor assembly, and a housing,
wherein the first camera lens and the second camera lens are installed in the housing, and
wherein the first motor assembly is installed to the housing and connected to the first camera lens, and is configured to drive the first camera lens to move relative to the second camera lens.

2. The zoom lens as described in claim 1, further comprising a first connector, wherein the first camera lens comprises a first connection hole, and the first connector has one end connected to an output shaft of the first motor assembly and the other end connected to the first camera lens through the first connection hole.

3. The zoom lens as described in claim 2, wherein the first connector is arranged along a length direction of the zoom lens and is engaged with the first connection hole through screw threads, and
wherein the first motor assembly is configured to drive the first connector to rotate relative to the first connection hole in such a manner that the first camera lens moves along the first connector, so as to change a distance between the first camera lens and the second camera lens.

4. The zoom lens as described in claim 1, wherein the second camera lens is movable relative to the housing to change a distance between the first camera lens and the second camera lens.

5. The zoom lens as described in claim 4, further comprising a second motor assembly, wherein the second motor assembly is installed to the housing and connected to the second camera lens, and is configured to drive the second camera lens to move relative to the first camera lens.

6. The zoom lens as described in claim 5, further comprising a second connector, wherein the second camera lens comprises a second connection hole, the second connector has one end connected to an output shaft of the second motor assembly, and the other end connected to the second camera lens through the second connection hole.

7. The zoom lens as described in claim 6, wherein the second connector is arranged along a length direction of the zoom lens and is engaged with the second connection hole through screw threads; and
wherein the second motor assembly is configured to drive the second connector to rotate relative to the second connection hole in such a manner that the second camera lens moves along the second connector, so as to change a distance between the first camera lens and the second camera lens.

8. The zoom lens as described in claim 1, wherein the housing is provided with a guide channel arranged along a length direction of the zoom lens, and
wherein the first camera lens and the second camera lens are installed to the guide channel and are movable relative to the guide channel.

9. The zoom lens as described in claim 8, wherein a first groove is provided at a side of the first camera lens facing towards the housing, a first ball is provided in the first groove, and the first camera lens is in contact with an inner wall of the guide channel through the first ball.

10. The zoom lens as described in claim 8, wherein a second groove is provided at a side of the second camera lens facing towards the housing, a second ball is provided in the second groove, and the second camera lens is in contact with an inner wall of the guide channel through the second ball.
